(19) United States
(12) Patent Application Publication
(10) Pub. No.: US 2017/0064914 A1
(43) Pub. Date: Mar. 9, 2017

(54) PLANTING BASEPLATE ASSEMBLY

(71) Applicant: National Chiao Tung University, Hsinchu City (TW)

(72) Inventors: Jehng-Jung KAO, Hsinchu (TW); Chao-Han LEE, Tainan City (TW)

(21) Appl. No.: 14/957,123

(22) Filed: Dec. 2, 2015

(30) Foreign Application Priority Data
Sep. 8, 2015 (TW) 104214502

(51) Int. Cl. A01G 25/00; A01G 1/00; E04D 11/00

(52) U.S. Cl. CPC A01G 25/00; E04D 11/002; A01G 1/007

(57) ABSTRACT

A planting baseplate assembly comprises a base, a water storage device, and a diversion element. The base includes a base body; a drain hole penetrating the upper and lower surfaces of the base body, wherein a connection member extends downward from the lower surface of the base body; a plurality of water guiding trenches mutually intersecting on the upper surface of the base body and interconnecting with the drain holes for water drainage; and a plurality of overflow holes disposed in and penetrated the water guiding trenches for water drainage. The water storage device includes a storage body and a connection neck to fix with the connection member. The diversion element is inserted through the drain hole and extended to the water storage device. The planting baseplate assembly is easy to assemble, favorable to environmental protection, and applicable to green roofs and various planting apparatuses.

### BACKGROUND OF THE INVENTION

1. Field of the Invention

The present invention relates to a planting baseplate assembly, particularly to a planting baseplate assembly with which different sizes of bottles can be connected to function as water storage devices.

2. Description of the Prior Art

Green roofs can insulate heat, save energy, reduce carbon emission, relieve the urban heat island effect, harvest rainwater, reduce burden of drainage systems, absorb air pollution, decrease noise, provide habitats for birds and small animals, protect roofs, prolong the life of roof, provide green area and open space, promote esthetics and value of buildings. However, a green roof demands a higher-standard water-proofing. It is laborious and time-consuming to cover soil on a green roof. However, an aged building is hard to sustain the soil on the green roof. Further, the soil on a green roof is inconvenient to maintain. Furthermore, the soil on a green roof impairs heat dissipation at night. Moreover, construction of a green roof needs professional personnel and a lot of money. The abovementioned problems impair popularization of green roofs. Thus, there is still room to improve green roof technology.

### SUMMARY OF THE INVENTION

In order to overcome the abovementioned problems, the present invention proposes a planting baseplate assembly, which has adjustable connection members adaptive to various sizes of water-storage bottles, and which is easy to assemble, favorable to environmental protection, and applicable to green roofs and various planting apparatuses.

One objective of the present invention is to provide a planting baseplate assembly, which comprises a base, a water storage device, and a diversion element. The base includes a base body being a plate-like structure; a drain hole penetrating the upper and lower surfaces of the base body and each having a connection member extending downward from the lower surface of the base body; a plurality of water guiding trenches mutually intersecting on the upper surface of the base body and interconnecting with the drain holes for water drainage; and a plurality of overflow holes disposed in and penetrating the water guiding trenches for water drainage. The water storage device includes a storage body and a connection neck, wherein the storage body is fixed to the connection member by the connection neck. The diversion element is inserted through the drain hole and extended to the water storage device.

In one embodiment, the base may be a plate-like structure.

In one embodiment, the base may be a tray-like structure.

In one embodiment, the base body and the base may be integrally fabricated into a tray body.

In one embodiment, the base is a tray-like structure; the planting baseplate assembly further comprises a pot body whose shape is corresponding to the shape of the base body; the pot body is secured to the base body by the plurality of water guiding trenches.

In one embodiment, the base is a tray-like structure; the planting baseplate assembly further comprises a plurality of side-plate assembling members disposed in and fixed to the edges of the base body and a plurality of side plates disposed corresponding to the edges of the base body and secured to the base body by the side-plate assembling members to form the tray-like structure.

In one embodiment, the connection member is integrally fabricated together with the drain hole or detachably connected with the drain hole.

In one embodiment, the connection member is detachably connected with the drain hole; the drain hole has a protrudent section protruding to the lower surface of the base body; the inner surface of the protrudent section has a first engagement member; the outer surface of the connection member has a second engagement element; the second engagement element is engaged with the first engagement element, whereby the connection member is secured to the drain hole.

In one embodiment, the second engagement element includes an upper rim, a lower flange, a concave surface, and a positioning surface; the first engagement element is engaged with the concave surface and the positioning surface, whereby the connection member is secured to the drain hole.

In one embodiment, the width of the upper rim is smaller than the diameter of the protrudent section of the drain hole. The width of the lower flange of the connection member is larger than the diameter of the protrudent section of the drain hole.

In one embodiment, the inner surface of the connection member has a first thread structure, and the connection neck of the water storage device has a second thread structure; the second thread structure is corresponding to the first thread structure and can be screwed into the first thread structure, whereby the first and second thread structures are fastened to each other.

In one embodiment, the planting baseplate assembly of the present invention further comprises a plurality of expansion elements disposed in the edges of the base body and used to assemble together a plurality of planting baseplate assemblies.

In one embodiment, the plurality of expansion elements and the base body are integrally fabricated into a one-piece component; the plurality of expansion elements include male elements and female elements; the female elements are engaged with the male elements to assemble together the plurality of planting baseplate assemblies.

In one embodiment, the plurality of expansion elements include first elements on the base body and detachable second elements; the second elements are engaged with the first elements to assemble together a plurality of planting baseplate assemblies.

Below, embodiments are described in detail in cooperation with the attached drawings to make easily understood the objectives, technical contents, characteristics and accomplishments of the present invention.

### BRIEF DESCRIPTION OF THE DRAWINGS

FIG. 1A is a diagram schematically showing a planting baseplate assembly according to one embodiment of the present invention;

FIG. 1B is an enlarged view schematically showing a base of a planting baseplate assembly according to one embodiment of the present invention;

FIG. 2 is a diagram schematically showing a planting baseplate assembly according to another embodiment of the present invention;

FIG. 3 is a diagram schematically showing a drain hole and a connection member of a planting baseplate assembly according to another embodiment of the present invention;

FIG. 4A and FIG. 4B are sectional views schematically a drain hole and a connection member of a planting baseplate assembly according to another embodiment of the present invention;

FIG. 5A is a diagram schematically showing a planting baseplate assembly with expansion elements according to one embodiment of the present invention;

FIG. 5B is a locally enlarged view of Area A in FIG. 5A;

FIG. 6A is a diagram schematically showing a planting baseplate assembly with expansion elements according to another embodiment of the present invention;

FIG. 6B is a locally enlarged view of Area B in FIG. 6A;

FIG. 7A is a diagram schematically showing a planting baseplate assembly with expansion elements according to a further embodiment of the present invention;

FIG. 7B is a locally enlarged view of Area C in FIG. 7A; and

FIG. 8 is a diagram schematically showing a planting baseplate assembly according to yet another embodiment of the present invention.

### DESCRIPTION OF THE PREFERRED EMBODIMENTS

The present invention will be described in detail with embodiments and drawings below. It should be noted: these embodiments and drawings are only to demonstrate the technical characteristics of the present invention but not to limit the scope of the present invention.

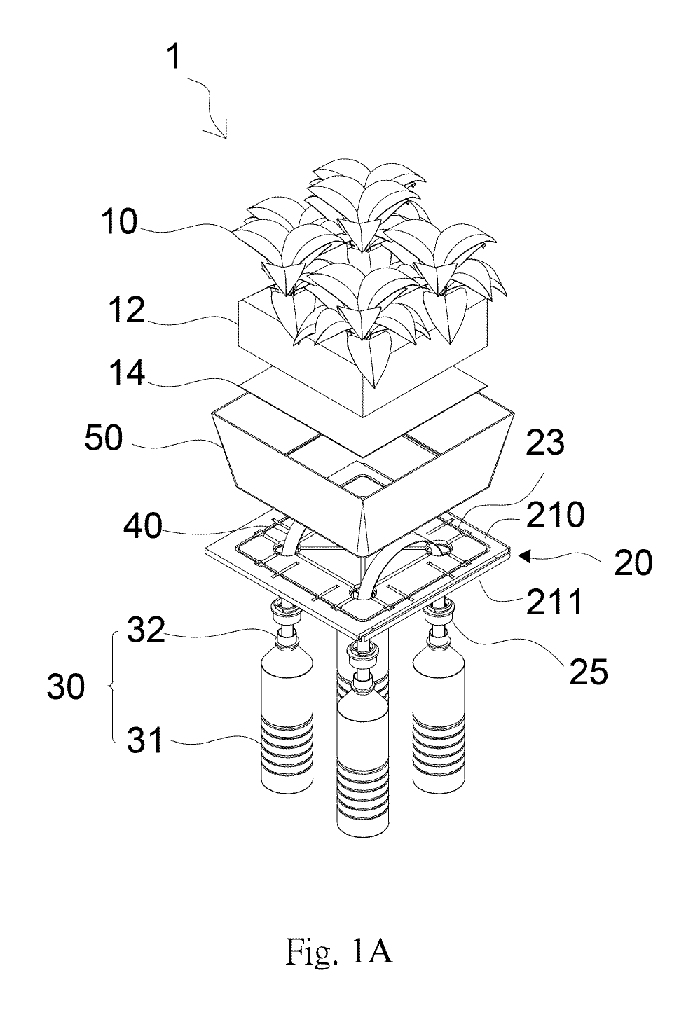

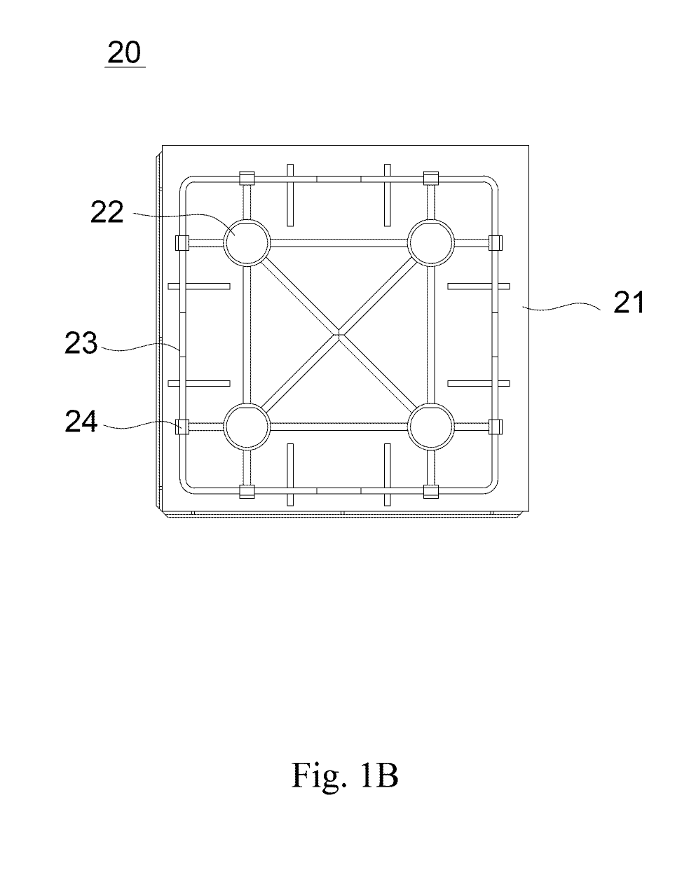

Refer to FIG. 1A and FIG. 1B. The planting baseplate assembly 1 of the present invention comprises a base 20, a water storage device 30 and a diversion element 40. The base 20 includes a base body 21, which is a plate-like structure; a drain hole 22 each penetrating the upper surface 210 and lower surface 211 of the base body 21 and each having a connection member 25 extending downward from the lower surface 211 of the base body 21; and a plurality of water guiding trenches 23 mutually intersecting on the upper surface 210 of the base body and interconnecting with the drain holes 22 for water drainage. It is noted that, the base 20 has a plurality of drain holes 22 interconnected by the water guiding trenches 23. In one embodiment, the base 20 further includes a plurality of overflow holes 24 disposed in and penetrating the plurality of water guiding trenches 23. While the water storage device 30 is completely filled with water, the overflow holes 24 drain out the excess water lest water accumulate in the base 20.

The water storage device 30 includes a storage body 31 and a connection neck 32. The connection neck 32 is secured to the connection member 25, whereby the water storage device 30 is installed in the base 20. The storage body 31 is a replaceable vessel of an arbitrary shape and an arbitrary size. The shape and size of the connection member 25 vary with the connection neck 32. The details thereof will be described thereinafter. The planting baseplate assembly 1 of the present invention further comprises at least one diversion element 40, which is a strip-like structure or a column-like structure. Each diversion element 40 can be simultaneously inserted into two drain holes 22 and extended through the base 20 to two water storage devices 30 toward to the direction of the lower surface of the base 20, as shown in FIG. 1A. In one embodiment, the diversion element 40 is inserted into a single drain hole 22 and extended to one water storage device 30 toward to the direction of the lower surface of the base 20. The diversion element 40 can guide water from the water storage device 30 to the surface of the base 20 to provide water for plants.

As shown in FIG. 1A, plants 10 can be planted in a medium 12 on the base 20. In one embodiment, a water-permeable member 14 made of a water-permeable material is arranged under the medium 12 to prevent plant roots from extending to the underneath water storage device.

In one embodiment, the base 20 is a plate-like structure, as shown in FIG. 1B. In another embodiment, the base 20 is a tray-like structure, wherein the base body and the base are integrally fabricated into a tray body (not shown in the drawings). In one embodiment, the planting baseplate assembly 1 of the present invention further comprises a pot body 50 whose shape is corresponding to the shape of the base body 21, as shown in FIG. 1A. The pot body 50 is secured to the base body 21 by a plurality of water guiding trenches 23, whereby to form a base 20 having a pot-like structure.

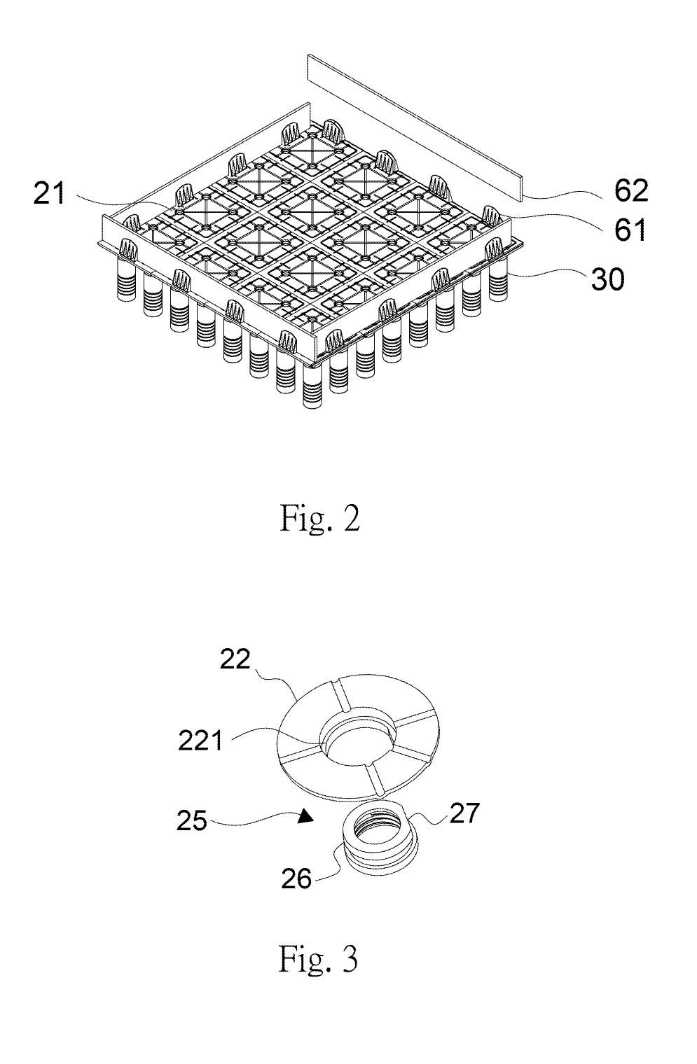

Refer to FIG. 2. In one embodiment, the planting baseplate assembly 1 of the present invention further comprises a plurality of side-plate assembling members 61 and a plurality of side plates 62. The plurality of side-plate assembling members 61 are installed in and fixed to the edges of the base body 21, and the plurality of side plates 62 are disposed corresponding to the edges of the base body 21 and fixed to the base body 21 by the plurality of side-plate assembling members 61, whereby is formed a base 20 with a pot-like structure. In the drawings, the base body is exemplarily depicted to have a rectangular shape, and the side-plate assembling members are exemplarily depicted to have a clamp structure. However, the present invention neither limits that the base body must have a rectangular shape nor limit that the side-plate assembling member must have a clamp structure. In the present invention, the base body can be arbitrarily fabricated to have any desired shape; the side-plate assembling member can be any element able to fix the side plate to the base body.

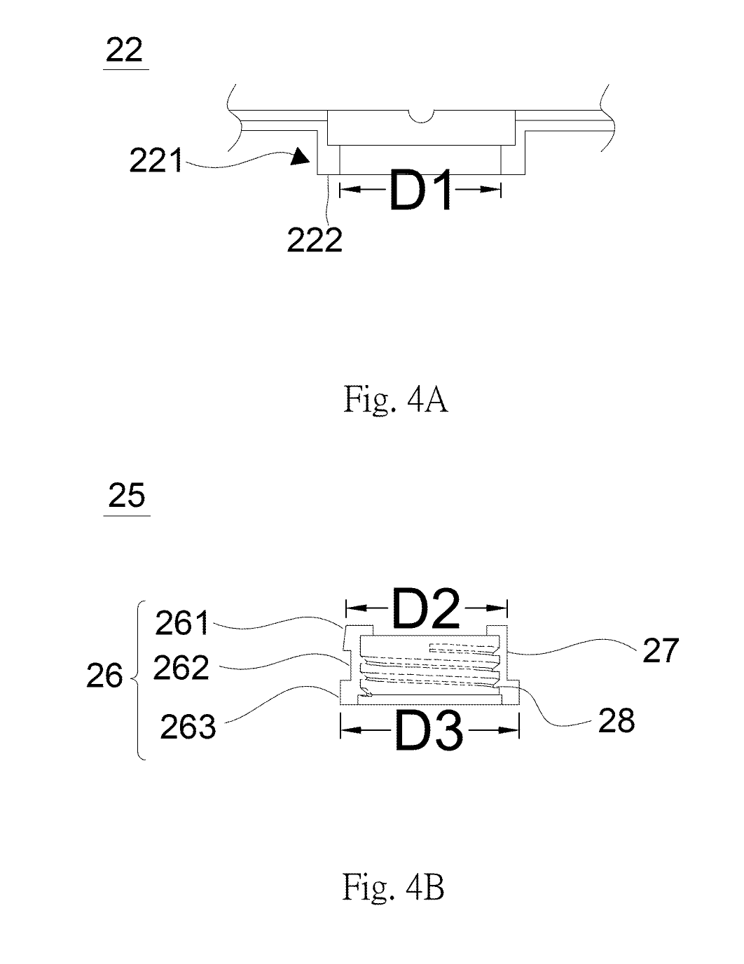

In one embodiment, the drain hole 22 and the connection member 25 are fabricated into a one-piece component. In another embodiment, the connection member 25 is detachably connected with the drain hole 22, as shown in FIG. 3, FIG. 4A and FIG. 4B, wherein the drain hole 22 has a protrudent section 221 protruding to the lower surface 210 of the base body 21. The inner surface of the protrudent section 221 has a first engagement member 222. The outer surface of the connection member 25 has a second engagement element 26, which includes an upper rim 261, a concave surface 262 and a lower flange 263. The outer surface of the connection member 25 further has a positioning surface 27. The first engagement element 222 of the drain hole 22 is engaged with the connection member 25 through the positioning surface 27 and the concave surface 262.

In FIG. 4B, the upper rim 261 of the connection member 25 is an annular structure having a trapezoid section. The width D2 of the upper surface of the upper rim 261 is smaller than the diameter D1 of the protrudent section 221 of the drain hole 22. The width D3 of the lower flange 263 of the connection member 25 is larger than the diameter D1 of the protrudent section 221 of the drain hole 22. Via the abovementioned design, while the connection member 25 is inserted into the drain hole 22, the second engagement element 26 and the positioning surface 27 of the connection member 25 are engaged with the first engagement element 222 of the drain hole 22, whereby the connection member 25 will not drop to the opposite direction.

In one embodiment, the inner surface of the connection member 25 has a first thread structure 28, and the connection neck 32 of the water storage device 30 has a second thread structure. The second thread structure of the water storage device 30 is an existing structure of an ordinary bottle. Therefore, the second thread structure of the water storage device 30 will not be further described or depicted in the specification. The second thread structure can be screwed into the first thread structure 28 to secure the water storage device 30 to the base 20. It should be noted: the size of the connection member can be adjusted according to diameter of the connection neck so as to adapt itself to different water storage devices, whereby to convenience DIY.

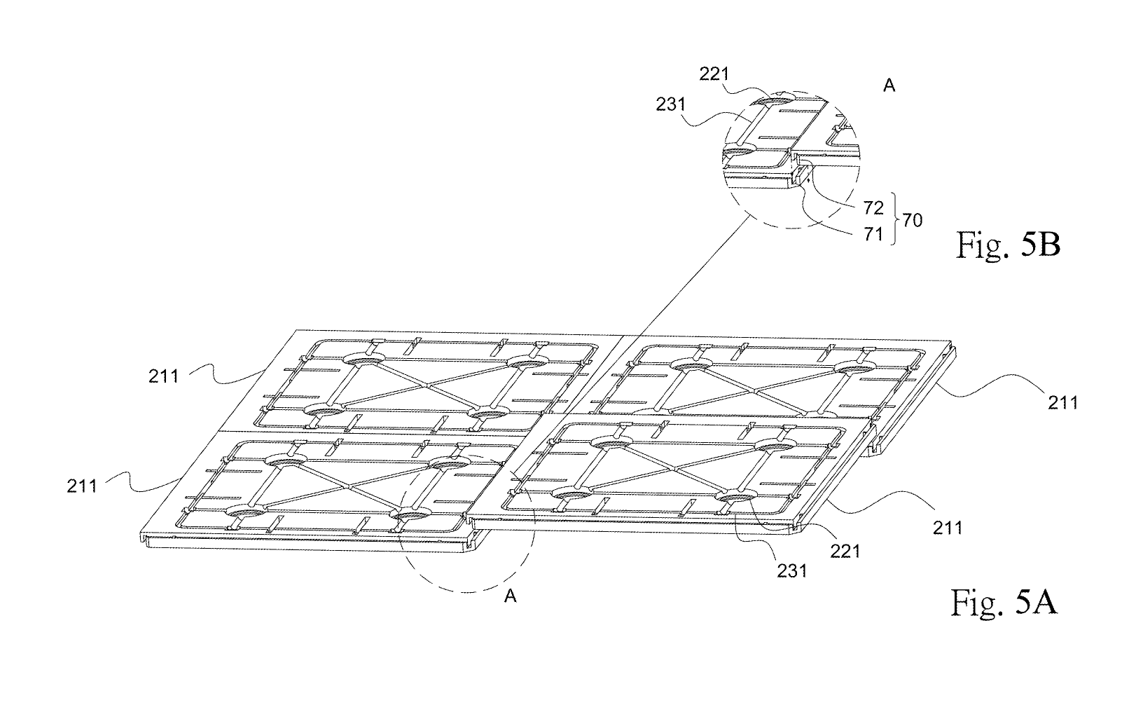

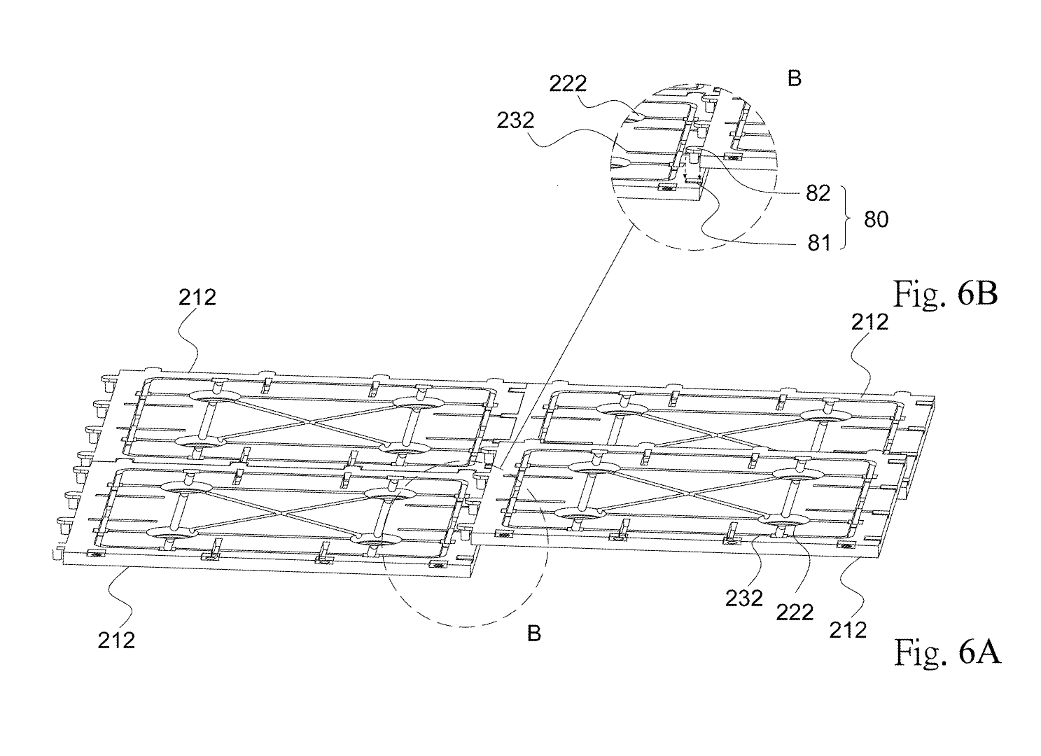

Via arranging a plurality of expansion elements in the edges of the base body, a plurality of planting baseplate assemblies can be assembled together. Refer to FIG. 5A and FIG. 5B. A plurality of expansion elements 70 are disposed in the edges of the base body 211. The expansion elements 70 and the base body 211 can be fabricated into a one-piece component. The expansion elements 70 include male elements 71 and female elements 72. The male elements 71 are respectively engaged with the female elements 72 to assemble a plurality of base bodies 211 together. In the embodiment shown in FIG. 5A and FIG. 5B, the male element and the female element are exemplarily depicted to be trenches able to press-fit to each other. However, the present invention does not limit thereto, the male element and the female element may have any suitable shape. Refer to FIG. 6A and FIG. 6B. In the embodiment shown in FIG. 6A and FIG. 6B, the base bodies 212 are assembled together with a plurality of expansion elements 80 disposed in the edges thereof, and the male elements 81 and the female elements 82 are in form of fasteners.

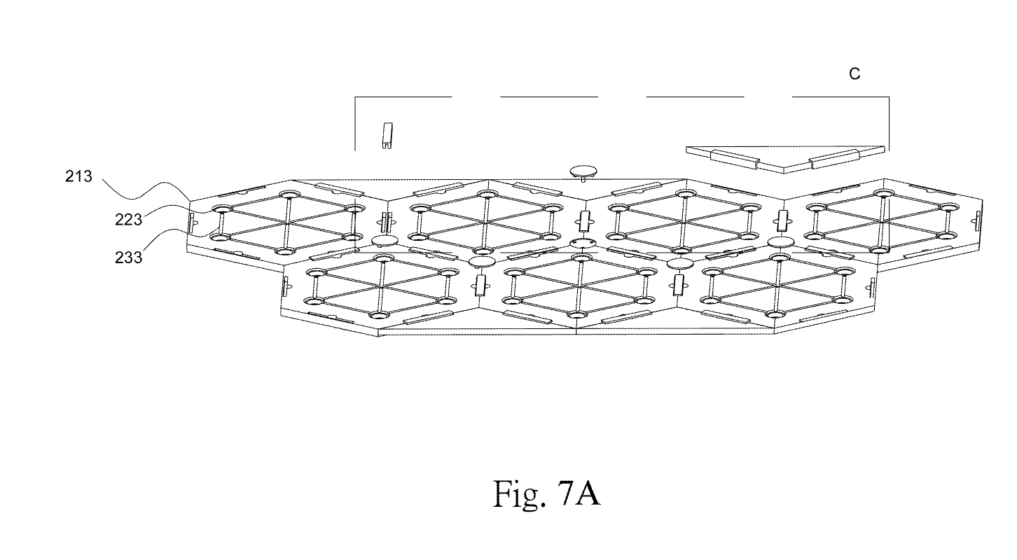

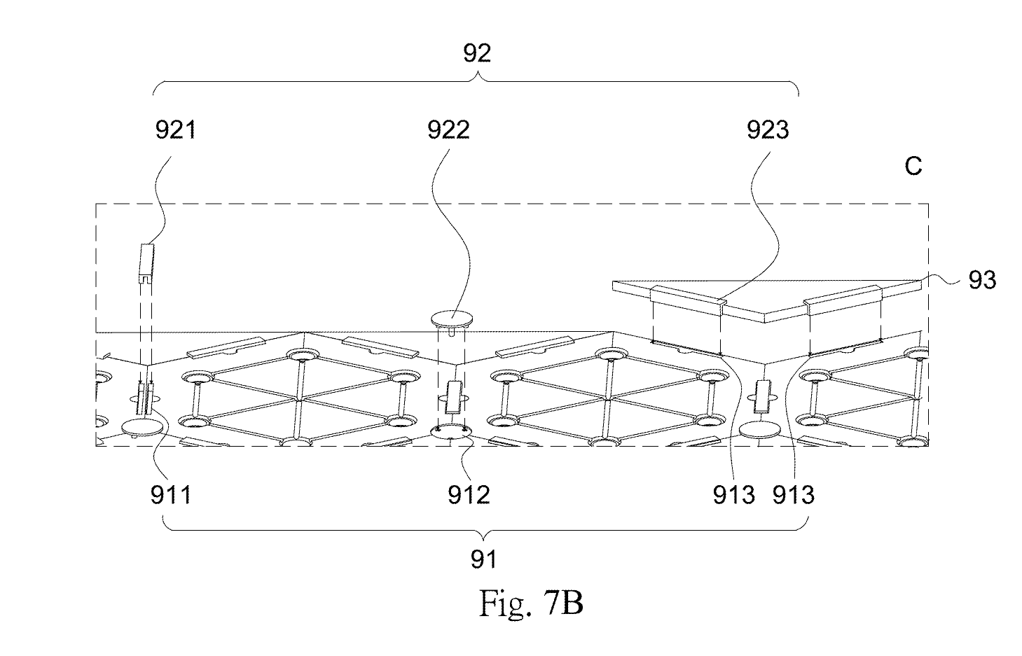

In one embodiment, the plurality of expansion elements includes first fixing elements on the base body and detachable second fixing elements. Refer to FIG. 7A and FIG. 7B. In the embodiment shown in FIG. 7A and FIG. 7B, the base body 213 has a hexagonal shape, and the first fixing elements 91 are disposed on the base body 213. The first fixing elements 91 can be arbitrarily fabricated to have desired shapes, such as the long-strip first fixing elements 911 and 913 or the circular first fixing element 912 shown in FIG. 7B. The second fixing element 92 can be press-fitted to the first fixing element 91. The second fixing element 92 may be an inverse-U section second fixing element 921 corresponding to the long-strip first fixing element 911 or a circular second fixing element 922 corresponding to the circular first fixing element 912. In one embodiment, the second fixing element 923 is disposed in an auxiliary element 93, press-fitted to the first fixing element and acquiring an auxiliary function simultaneously. In one embodiment, the auxiliary element 93 is a triangular board for modifying the assembled hexagonal base bodies. The detachable second fixing elements 92 are press-fitted to the first fixing elements 91 on the base bodies 213 to assemble the plurality of base bodies 213 together. In the embodiment shown in FIG. 7A and FIG. 7B, the base body is exemplified by the hexagonal base body. However, the present invention does not limit that the base body must be a hexagonal one. In the present invention, the expansion elements may also be used to assemble base bodies of a different shape.

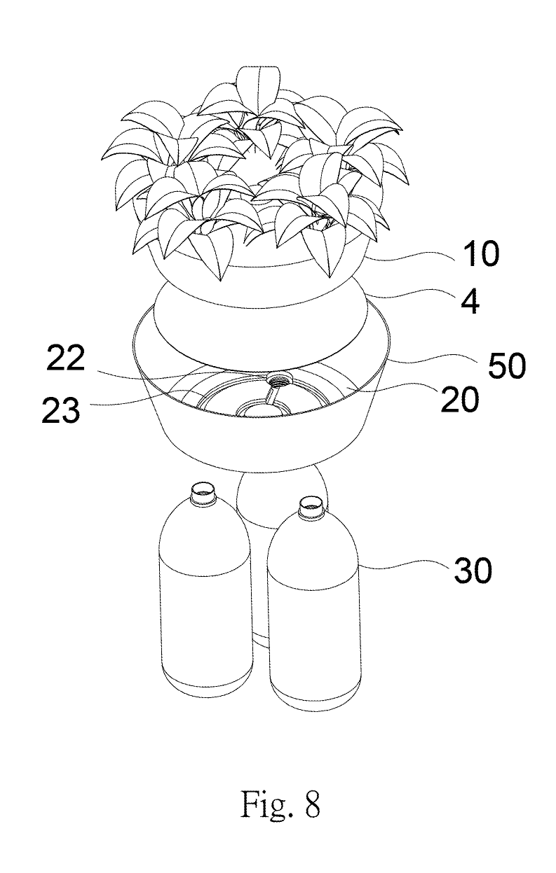

It should be particularly mentioned: the rectangular or hexagonal base is only to exemplify the base of the present invention but not to limit the shape of the base of the present invention. The base may be fabricated to have any shape according to requirement. For example, in the embodiment shown in FIG. 8, the base 20 has a circular shape, used together with a circular pot body 50.

In summary, the present invention proposes a planting baseplate assembly, which is easy to assemble, economical in time and manpower of construction, and lightweight. While used to construct green roofs, the planting baseplate assemblies of the present invention are sustainable by aged buildings. Thereby is overcome the problem of bulky green roofs. Because the connection member of the present invention is adjustable, the PET bottles of different sizes can be recycled to function as water storage devices. Therefore, the user is easy to acquire the material of the present invention and able to assemble the present invention in a DIY way. Further, the present invention is also very favorable to environmental protection.

The foregoing embodiments are used only for illustrating the technical ideas and caracteristics of the present invention, it is purposed to make person ordinary skill in the art to understand and implement the present invention, but for limitation to the claims of the present invention. That is, the equivalent change and modification according to the sprit disclosed in the present invention should be covered by the appended claims.

What is claimed is:

1. A planting baseplate assembly comprising
a base including
a base body being a plate-like structure;
a drain hole penetrating an upper surface and a lower surface of said base body, wherein a connection member extends downward from said lower surface of said base body;
a plurality of water guiding trenches intersecting on said upper surface of said base body to guide water and interconnecting with said drain holes; and
a plurality of overflow holes disposed in and penetrating said water guiding trenches to drain water;
a water storage device including a storage body and a connection neck and secured to said connection member through said connection neck; and
a diversion element inserted into said drain hole and extending to said water storage device.

2. The planting baseplate assembly according to claim 1, wherein said base is a plate-like structure.

3. The planting baseplate assembly according to claim 1, wherein said base is a tray-like structure.

4. The planting baseplate assembly according to claim 3, wherein said base body and said base are integrally fabricated into a tray body.

5. The planting baseplate assembly according to claim 3, further comprising a pot body whose shape is corresponding to a shape of said base body, wherein said pot body is secured to said base body by said water guiding trenches.

6. The planting baseplate assembly according to claim 3, further comprising
a plurality of side-plate assembling members disposed in and secured to edges of said base body; and
a plurality of side plates disposed corresponding to said edges of said base body, and secured to said base body by said side-plate assembling members to form said tray-like structure.

7. The planting baseplate assembly according to claim 1, wherein said drain hole and said connection member are fabricated into a one-piece component or detachably connected with each other.

8. The planting baseplate assembly according to claim 7, wherein said drain hole and said connection member are detachably connected with each other; said drain hole includes a protrudent section protruding to said lower surface of said base body, and wherein an inner surface of said protrudent section has a first engagement element, and wherein said connection member has a second engagement element, and wherein said first engagement element and said second engagement are engaged with each other to secure said connection member to said drain hole.

9. The planting baseplate assembly according to claim 8, wherein said second engagement element includes an upper rim, a lower flange, a concave surface and a positioning surface, and wherein said connection member is secured to said drain hole via engaging said concave surface and said positioning surface with said first engagement element.

10. The planting baseplate assembly according to claim 9, wherein a width of said upper rim of said connection member is smaller than a diameter of said protrudent section of said drain hole, and wherein a width of said lower flange of said connection member is larger than said diameter of said protrudent section of said drain hole.

11. The planting baseplate assembly according to claim 1, wherein an inner surface of said connection member has a first thread structure, and wherein said connection neck of said water storage device has a second thread structure, and wherein said first thread structure is corresponding to and screwed into said second thread structure.

12. The planting baseplate assembly according to claim 1 further comprising a plurality of expansion elements disposed on the edge of said base body and used to assemble together said planting baseplate assemblies.

13. The planting baseplate assembly according to claim 12, wherein said expansion elements and said base body are fabricated into a one-piece component, and wherein said expansion elements include male elements and female elements, and wherein said male elements are press-fitted to said female elements to assemble together said planting baseplate assemblies.

14. The planting baseplate assembly according to claim 12, wherein said expansion elements includes first fixing elements disposed on said base body and detachable second fixing elements, and wherein said first fixing elements are press-fitted to said second fixing elements to assemble together said planting baseplate assemblies.
